(19) United States
(12) Patent Application Publication
(10) Pub. No.: US 2012/0084749 A1
(43) Pub. Date: Apr. 5, 2012

(54) PROGRAMMING LANGUAGE SUPPORT FOR REACTIVE PROGRAMMING

(75) Inventors: Jeffrey Van Gogh, Redmond,, WA (US); Henricus Johannes Maria Meijer, Mercer Island, WA (US); John Wesley Dyer, Monroe, WA (US); Bart De Smet, Bellevue, WA (US); Danny Van Velzen, Redmond,, WA (US)

(73) Assignee: MICROSOFT CORPORATION, Redmond, WA (US)

(21) Appl. No.: 12/896,688

(22) Filed: Oct. 1, 2010

(51) Int. Cl. G06F 9/44

(52) U.S. Cl. 717/106; 717/136

(57) ABSTRACT

Program language support is provided to facilitate reactive programming. Code can be provided that initiates conversion between a first-class pattern and a second-class pattern, wherein the patterns operate with respect to push-based data. Support is also provided for producing and consuming push-based data in accordance with an iterator pattern, for example.

### BACKGROUND

Data processing is a fundamental part of computer programming. One can choose from amongst a variety of programming languages with which to author programs. The selected language for a particular application may depend on the application context, a developer's preference, or a company policy, among other things. Regardless of the selected language, a developer will ultimately have to deal with data, namely querying and updating data.

Data can be classified as either pull-based or push-based as function of how the data is acquired. Pull-based data is data that is actively retrieved. For example, a program can iterate over a collection of items in an array to request and retrieve items. Similarly, data can be pulled from a local or remote database. By contrast, push-based data is provided to a program at arbitrary times. A classic example is a user interface that pushes values in response to user input such as mouse movement or item selection. Asynchronous computations can also be viewed as sources of push-based data in light of communication latency, potential errors, or timeouts. For instance, a program can request that a computation be performed on a remote machine and be notified of the result when the computation is complete. However, the exact time that the result of the computation is returned is unknown to the program and can vary based on network latency as well as remote machine processing power and load, among other factors.

Working with pull-based data can be called interactive programming while working with push-based data can be termed reactive programming. In an interactive pull-based program, program code requesting the data is in control and the code will wait or block until data becomes available before continuing execution. Alternatively, in a reactive push-base program, the environment (e.g., database, web service, UI framework . . . ) is in control and determines when data is delivered to the application. Here, the program code need not wait or block. Rather, the code can continue to execute and react appropriately when data is provided asynchronously thereto.

Reactive programming (a.k.a. asynchronous and/or event-based programming) is becoming increasingly prevalent in modern computer applications. In particular, reactive programming is beneficial in the context of multi-core and distributed or cloud computing. In these cases, work can be distributed across two or more cores or computers, for example. Nevertheless, reactive programming can be quite burdensome for developers.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to providing programming language support for reactive programming. A library, or like reusable component, can provide code for composing asynchronous and event-based programs over push-based data collections external to a program itself. Adding support to a programming language for at least a subset of functionality provided by such a library facilitates employment of the library and consequently reactive programming. In accordance with one aspect of the disclosure, support can be provided for converting between first-class and second-class patterns including events, asynchronous computation, and properties. In accordance with another aspect of the disclosure, support can be provided to aid production and consumption of push-based data, for example utilizing an iterator pattern.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of program language support system.

FIG. 2 is a block diagram of a representative support component.

FIG. 3 is a block diagram of a representative code-generation component.

FIG. 4 is a flow chart diagram of a method of facilitating reactive programming.

FIG. 5 is a flow chart diagram of a method of converting a second-class pattern to a first-class pattern.

FIG. 6 is a flow chart diagram of a method of converting a first-class pattern into a second-class pattern.

FIG. 7 is a flow chart diagram of a method of facilitating creation and consumption of push-based data.

FIG. 8 is a schematic block diagram illustrating a suitable operating environment for aspects of the subject disclosure.

### DETAILED DESCRIPTION

Details below are generally directed toward adding programming language support for reactive programming. A reactive library or like reusable component can provide functionality associated with asynchronous and event-based programming or in other words, reactive programming. Stated differently, the library can to provide support for push-based data. More specifically, the reactive library can expose such functionality with first-class patterns, entities, or the like (e.g., IObservable, IProperty . . . ). Conventional programming languages include functionality for event and asynchronous programming utilizing second-class patterns, and entities, among other things. Support for reactive programming can be integrated within a programming language to aid utilization, and consequently reduce the learning curve associated with, a reactive library, for example. In particular, conversions can be initiated between first-class and second-class patterns. Furthermore, program language support can be provided for producing and consuming push-based data, for example based on an iterator pattern.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

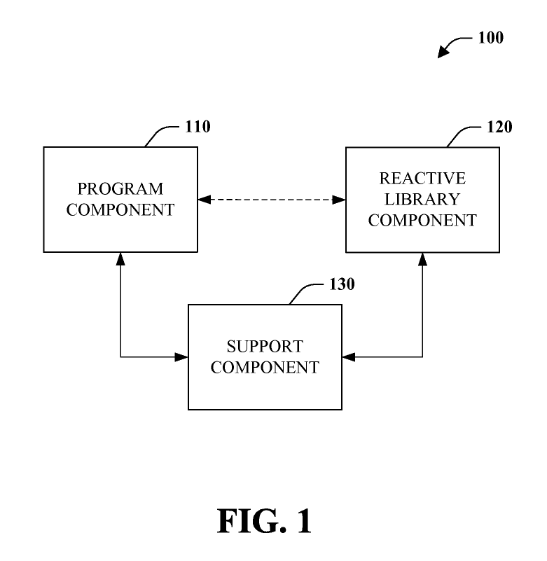

Referring initially to FIG. 1, a program support system 100 is illustrated. The system includes a program component 110 and a reactive extension component 120. The program component 110 represents a software program specified in a particular programming language that performs specified operations when executed. For example, the program component 110 can be source code authored by a developer in a high-level programming language (e.g., C#®, Visual Basic® . . . ). The reactive library component 120 can correspond to a collection of reusable code and data that provides services to the program component 110. More specifically, the reactive library component 120 can be embodied as a software library that facilitates asynchronous and event- or push-based programming, or in other words, reactive programming, by exposing first-class patterns (e.g., IObservable, IProperty . . . ) over push-based data collections. While the program component 110 can support reactive programming, it is often represented with second-class patterns or existing language features are misused to simulate the desired behavior. Accordingly, the reactive library component 120 can extend the functionality of the program language utilized to specify a program to include first-class patterns over push-based data, among other things.

A first-class pattern is a design pattern (e.g., a solution or framework for addressing a problem or computational issue) that is implemented with a first-class object or entity (e.g., a program language concept). Stated differently, a first-class pattern can be implemented with a programmatic construct can be used with a maximum set of language constructs, typically because of its treatment as an object. This allows such a construct to be passed as a parameter (e.g., to define constructs such as “operators” over first-class objects), returned as a result, or assigned to a variable, among other things. In other words, first-class indicates that no other construct has more capabilities beyond those of a first-class entity. By contrast, second-class indicates that a construct is constrained in some manner such that the entity cannot be passed as a parameter or assigned to a variable, for instance.

The program support system 100 also includes a support component 130 that provides support or assistance to the program component 110 with respect to employment of the reactive library component 120. For instance, the support component 130 can at least initiate conversion of one or more second-class patterns of the program component 110 into one or more first-class patterns of the reactive library component 120. Furthermore, the support component 130 can provide functionality to allow production and consumption of push-based data in the same or similar manner as pull-based data, for instance. Overall, the support component 130 can extend a programming language to make it easier for a user to author reactive programs, for example utilizing the reactive library component 120. Although not limited thereto, the functionality provided by the support component 130 can be implemented by a compiler or like component in accordance with one embodiment.

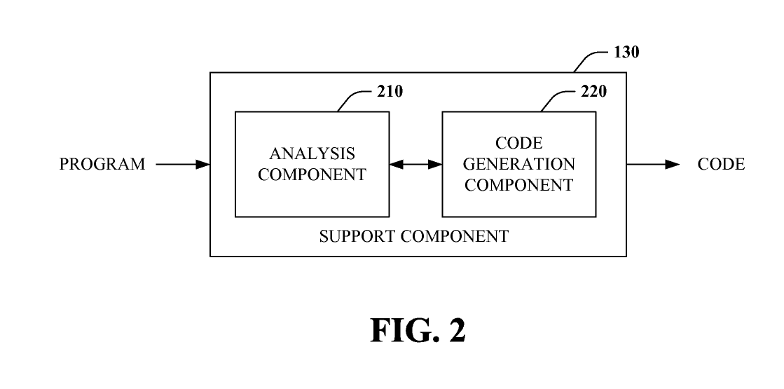

FIG. 2 depicts a representative support component 130. As shown, the support component can include an analysis component 210 and a code generation component 220. The analysis component 210 can analyze a program, or more particularly program syntax, to identify various specified patterns and/or entities such as but not limited to events, asynchronous computations, and properties. The code generation component 220 can generate programming language code, also referred to as support code, that at least causes or initiates conversion between first-class and second-class patterns, namely from a first-class pattern to a second-class pattern or from a second-class pattern to a first-class pattern. Additionally or alternatively, the code generation component 220 can generate code to support producing and consuming push-based data, for instance based on an iterator pattern.

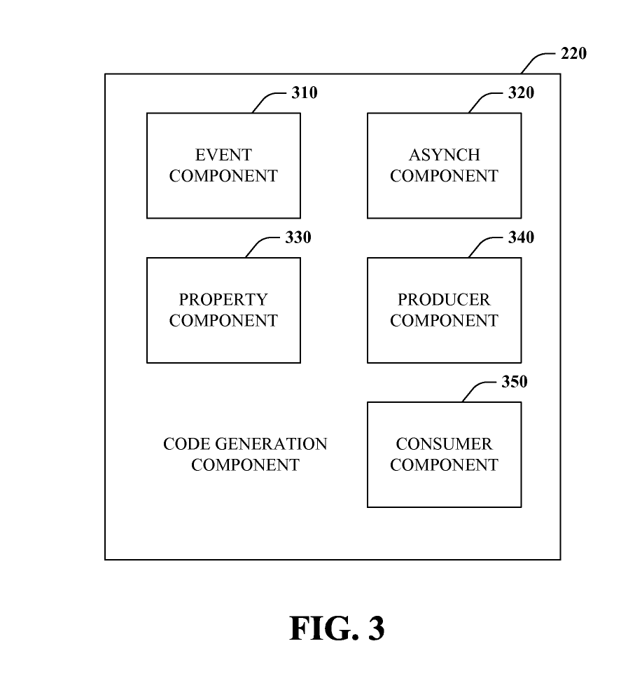

FIG. 3 is a block diagram of a representative code-generation component 220 to aid clarity and understanding with respect to aspects of the claimed subject matter. As depicted, the code generation component 220 includes an event component 310, an asynchronous component 320, a property component 330, a producer component 340, and a consumer component 350.

The event component 310 generates code to at least initiate conversion to and from first-class event patterns. Many programming languages have a second-class representation of events. For example, an event can be defined as follows:

public event EventHandler Click;
This code instructs a compiler to generate the following code (simplified):

```
// private backing field that stores subscriptions, also used to fire
// event
private EventHandler Click;
public void add_Click(EventHandler value)
{
  Click = Delegate.Combine(Click, value);
}
    public void remove_Click(EventHandler value)
{
  Click = Delegate.Remove(Click, value);
}
```

Furthermore, additional metadata can be added to the compiled code (e.g., intermediate language code (IL)) that makes callers aware of the availability of this event. The event can be fired from within a class by invoking the delegate that is currently in the backing field:
if (Click!=null) Click.Invoke(o,e);
Events can be hooked up and unsubscribed to by calling “+=” (add event) or “−=” (remove event) on the event, which can turn into calls to “add” and remove methods described earlier.

However, events are not first-class objects but rather are second-class objects or a second-class pattern. As a result, several issues exist. First, events alone cannot be passed around. More specifically, the only way to pass a second-class event is by passing its containing object. Further, second-class events are not compositional, for example, a filter or projection cannot be written over them, and events cannot be joined with other events, among other things. Additionally, only an internal class can fire the event (e.g., through a backing field). Furthermore, only values can be returned. Errors cannot be signaled, and there is no notion of completion. Still further yet, in order to be able to unhook an event, the delegate that was added needs to be saved.

The reactive library component 120 of FIG. 2 can allow users to specify first-class events over push-based data. For example:

public event IObservable<SomeType> Click;
This code can instruct a compiler to generate the following code (simplified):

// private backing field that stores subscriptions, also used to fire
//event
private Subject<SomeType> Click = new Subject<SomeType>( );
public IObservable<SomeType> Click
{
get { return _click.AsObservable( ); }
}

To subscribe to this event, users can write:
var subscription=object.Click.Subscribe( . . . );
To unsubscribe to the event later, a user can write:
subscription.Dispose( );
To fire events, a developer can write inside a class:

### Click.OnNext(value);

To signal an error a user can write:

### Click.OnError(error);

To signal completion a developer can write:

### Click.OnCompleted( );

Further, if a developer wants to allow external code to fire an event, the developer can write:
public event ISubject<SomeType> Click;
Which will change the signature of the public property allowing external callers to call “OnNext,” “OnError,” or “OnCompleted.” Of course, other syntax can be utilized to specify first class events which can then be converted by the compiler into appropriate calls (e.g., “+=” and “−=”).

The benefits of this first-class event pattern are numerous. First, first-class events can be passed around. Second, events are compositional. Further, a developer can specify if external people are allowed to fire an event. Additionally, signaling is more expressive (e.g., provide a value, signal an error, signal completed . . . ). Further yet, unsubscribing from an event does not require a delegate to be saved or kept around.

The differences between a conventional program representation of an event and the reactive library representation are clear and copious. The event component 310 provides the functionality to bridge these differences. In particular, there is a lot of existing code that implement second-class events. Accordingly, the event component 310 can aid bringing those events into the reactive programming context. By way of example, imagine a button class has an event click, like this:

class Button
{
public event EventHandler Click;
}

To convert this existing event to a first-class event the following code can be added by the event component 310:

var click = Observable.FromEvent<EventHandler, EventArgs>(e=>new
EventHandler(e), e=>button.Click +=e, e=> button.Click −= e);
click.Subscribe(....)

Consequently, a user is able to call “Subscribe” directly on the public event:
button.Click.Subscribe( . . . );
When such syntax is detected for example by the analysis component 210 of FIG. 2, the event component 310 can automatically inject the above code to support use of a first-class event. Optionally, the event component 310 can cache this conversion to avoid the overhead of doing the conversion several times. Analogous operation can also be performed by the event component 310 in the opposite direction, namely from a first-class event to a second-class event.

The asynchronous component 320 can generate code to support first-class asynchronous computations or functions. More specifically, the result of an asynchronous computation or function can become a first-class object. Various patterns can be utilized by a program to specify asynchronous computation including BeginInvoke/EndInvoke. For example, consider the following pseudo-code snippet:

var result = foo.BeginInvoke(“a”);
var x = foo.EndInvoke(result);

Note that before anything can be done with the result EndInvoke needs to be called. The asynchronous component 320 can generate code to convert to a first-class object as follows:

var asyncFoo = Observable.FromAsyncPattern(string, int)
(foo.BeginInvoke, foo.EndInvoke)

Here, “var’ is really “Func(string IObservable<int>).” As a result, a user can use asyncFoo as a first-class object such as:
var result=asyncFoo(“a”);
Additionally, converting to an asynchronous computation to a first-class entity can be helpful in dealing with exceptions, among other things, since the reactive library component 120 can allow return of errors as well as values. Of course, the asynchronous component 320 can also provide support for converting in the opposite direction such as from a “Func<string, IObservable<int>>” to a “BeginInvoke/EndInvoke,” where desired.

Furthermore, program language support can be added. By way of example and not limitation, program language support can be provided as follows:

Public bool IsEven(int value)
{
...
}
Func<int, IObservable<bool>>asyncIsEven = asyncof(IsEven);

Here, the “asyncof” keyword could trigger generation of the correct call to “Observable.FromAsyncPattern.”

Just like events, properties in most modern programming languages are not first class. That is, the property itself cannot be passed around. Rather, an object containing the property may be passed around. In addition, external code cannot easily listen for changes to a property. To avoid this, developers often implement an INotifyPropertyChanged pattern, where the developer has to carefully code each property to fire an event upon changes. Below is an example of such the existing pattern with respect to properties:

```
class Customer : INotifyPropertyChanged
{
    public event PropertyChangedEventHandler PropertyChanged;
    private void NotifyPropertyChanged(string info)
    {
        if (PropertyChanged != null)
            PropertyChanged(this, new
            PropertyChangedEventArgs(info));
    }
    private string _customerName;
    public string CustomerName
    {
        get { return _customerName; }
        set
        {
            if (value != _customerName)
            {
                _customerName = value;
                NotifyPropertyChanged(“CustomerName”);
            }
        }
    }
    private string _phoneNumber;
    public string PhoneNumber
    {
        get { return _phoneNumber; }
        set
        {
            if (value != _phoneNumber)
            {
                _phoneNumber = value;
                NotifyPropertyChanged(“CustomerName”);
            }
        }
    }
}
```

In the context of a reactive library, properties are represented as first-class entities, for example, as follows:

```
class Property<T> : IObservable<T>, IObserver<T>
{
    private List<IObserver<T>> m_observers;
    private Notification<T> m_value;
    public T Value
    {
        get { return m_value.Value; }
        set { OnNext(value); }
    }
    private IDisposable Subscribe(IObserver<T> observer)
    {
        m_{—} observers.Add(observer);
        return Disposable.Create(( )=>
        m_{—} observers.Remove(observer));
    }
    public void OnNext(T value)
    {
        m_value = new Notification<T>.OnNext(value);
        foreach(var observer in m_{—} observers.ToArray( ))
        {
            observer.OnNext(value);
        }
    }
    public void OnError(Exception exception)
    {
        m_value = new Notification<T>.OnError(exception);
        foreach(var observer in m_observers.ToArray( ))
        {
            observer.OnError(exception);
        }
    }
    public void OnCompleted( )
    {
        m_value = new Notification<T>.OnCompleted( );
        foreach(var observer in m_observers.ToArray( ))
        {
            observer.OnCompleted( );
        }
    }
}
```

With this class, first-class properties in a language can be implemented. For example:

```
class Customer
{
  public property CustomerName {get; set; }
  public property PhoneNumber {get; set;}
}
```

From the above the following code can be generated:

```
class Customer
{
    public Property<string> CustomerName {get; private set;}
    public Property<string> PhoneNumber {get; private set;}
    public Customer( )
    {
        CustomerName = new Property<string>( );
        PhoneNumber = new Property<string>( );
    }
}
```

A first-class property like this can be read or assigned as follows:

var x = somebody.CustomerName;
somebody.CustomerName = “some body”;

This code can be automatically rewritten to the following to maintain existing language semantics:

var x = somebody.CustomerName.Value;
somebody.CustomerName.Value = “some body”

The first-class property can be accessed in a program by using the “property” keyword:
var firstClass=property(Customer.CustomerName)
“firstClass” is now typed as “Property<string>” and can be subscribed to or listened to.

The property component 330 can generate code to convert a second-class property to a first-class property as described briefly above. Similarly, the property component can generate code to convert from a first-class property to a second-class property where desired.

Note that events and properties are related. In one implementation, a property can be converted to an “Observable” interface form. Similarly, an event can be converted to an “Observable” interface form. Once a property is converted to a first-class property, a relationship is discovered between properties and events. More specifically, properties are just special events, or in other words, events are just special properties.

The code generation component 220 can also facilitate interaction with first-class entities by way of the producer component 340 and the consumer component 350. Computer languages can support interaction with pull-based data utilizing an enumerable interface (e.g., IEnumerable). Similarly, the reactive library component 120 of FIG. 1 can support interaction with asynchronous or push-based data with an observable interface (e.g., IObservable). To aid program development, a single interface can be utilized to interact with both pull-based and push-based data. In accordance with one embodiment, the currently supported enumerable interface can be employed for this purpose.

To enable this functionality, the producer component 340 can generate code that maps enumerable features to observable features. For example, an IEnumerable can include instructions for “yield return” (produce a value), “yield break” (yield control to caller), and “throw” (signal occurrence of an anomalous situation-exception). These instructions can be mapped to observable instructions with similar functionality with respect to push-based data, namely “OnNext” (provides next value from a data source) “OnCompleted” (signals that source is done providing values), and “OnError” (signals an exception).

The consumer component 350 can generate code that enables iteration over a push-based data in the same or similar manner as iteration is implemented over pull-based data. In other words, IEnumerable iterators can be implemented using a yield pattern as follows:

```
IEnumerable<string> GetData(Reader reader)
{
    while(!reader.EOF)
        yield return reader.ReadLine( );
}
```

While this code looks to a developer as a single imperative method, in the background code is generated to produce a state machine to change control flow after each call to “MoveNext( )” on an enumerable/enumerator pair. This makes program development a lot easier since developers can provide implementations for IEnumerable without having to thing about or deal with state machines. The same issue now applies to observable, push-based data sequences.

As a result of code generated by the consumer component 350 a program language can be extended to allow specification of the following:

```
IObservable<string> GetData(Reader reader)
{
    while(!reader.EOF)
        yield return reader.ReadLine( );
}
```

For this to work, mapping of “yield return” to a call to “OnNext,” “yield break” to a call to “OnCompleted,” and any implicit or explicit exceptions thrown sent to “OnError” can be exploited. Furthermore, the consumer component 350 can be configured to all yield calls to be nested in closures. To support detection of “unsubscribe,” the consumer component 350 can also rewrite an outer “try finally” block of instructions to be executed on unsubscribe, in a similarly manner as is currently done with “IDisposable” on “IEnumerable.” Accordingly, the consumer component 350 can generate code as follows:

```
IObservable<string> GetData(Reader reader)
{
    return Observable.Create<string>(observer=>
    {
        try
        {
            while(!reader.EOF)
                observer.OnNext(reader.ReadLine( ));
        }
        catch(Exception e)
        {
              observer.OnError(e);
        }
    }
}
```

Since these operations can still block potentially, a user can be allowed to cause non-blocking control flow code to be generated. This can be accomplished by introducing a new keyword such as “start.” For example, the above code can be changed to the following:

```
IObservable<string> GetLinesLongerThanTenChars(Reader reader)
{
    while(!reader.EOF)
    {
        var asyncLine = reader.ReadLineAsync( );
        var results = start asyncLine;
        var next = results.NextValue;
        if (results[0].length > 10)
            yield return results[0];
    }
}
```

The “start” keyword could instruct generation of code in a state machine that caches values coming in to “asyncLine” into an object that is stored in the “results” variable. Once data of “results” is accessed, code can be generated in the state machine to release execution control until the data request is available. The way “results” is accessed can determine what policy is used for releasing control. Consider the following access patterns and code generation policies of TABLE 1:

TABLE 1

| Access Pattern | Policy |
|---|---|
| results.NextValue | Release control until next value arrives |
| results.CurrentValue | Do not yield control. Return value immediately if a |
| | value arrived between start and request of current |
| | value. If no value came in, a default value can be |
| | returned (e.g. null for reference types, |
| | empty for value types) |
| results.ToArray( ) | Release control until OnCompleted message |
| | arrives on the source observable |
| foreach over | Transfer control after each incoming message |
| results object | |

Of course, more complex control releasing can be done as well, for example on a join of multiple results (e.g., results1.Join(results2)).

The “start” keyword can be used in methods that are using the yield iteration pattern returning IObservable<something> as well as methods returning void. In the case of the latter, the state machine generated can yield control to the calling method upon the first release of control.

Although not illustrated for purposes of brevity, the analysis component 210 of FIG. 2 can include sub-components of similar names as those specified with respect to the representative code-generation component 220 of FIG. 3. More particularly, analysis can be focused with respect to each instance. For example, a sub-component can exist to analyze a program and identify second-class events or properties. Furthermore, the analysis component 210 can recognize explicit conversions, for example, as well as implicitly requested conversions.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the support component 130 can employ such mechanisms to determine or infer user intent from a program and generate code to implement that intent over push-based data.

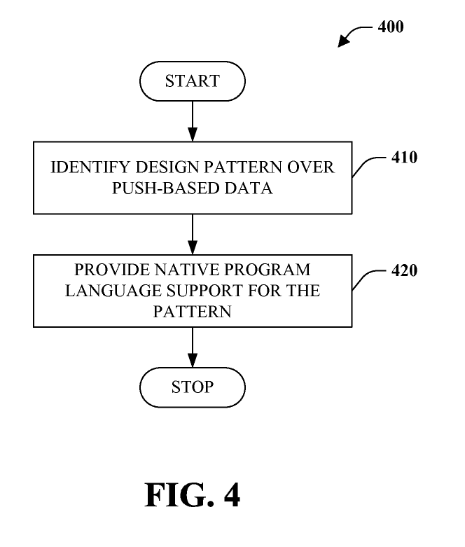

In view of the exemplary systems described supra, methodologies that may be implemented in accordance with the disclosed subject matter will be better appreciated with reference to the flow charts of FIGS. 4-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a method 400 of facilitating reactive programming is illustrated. At reference numeral 410, a design pattern is identified in a program over push-based data. For example, an event or asynchronous computation pattern can be identified. At reference numeral 420, native program language support is automatically provided to facilitate employment of external code for composing asynchronous and event-based programs over push-based data collections. In one particular implementation, code can be generated by a compiler to support use of a library of code specifying extensions that enable reactive programing with respect to push-based data collections.

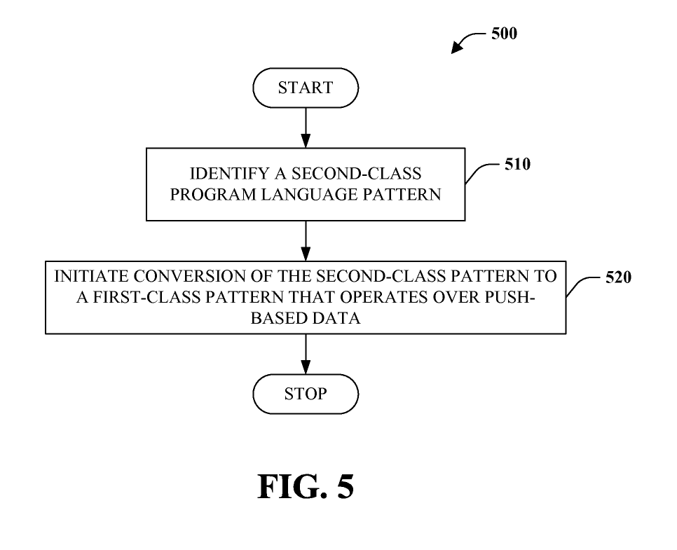

FIG. 5 is a flow chart diagram depicting a method 500 of converting a second-class pattern to a first-class pattern. At reference numeral 510, a second-class program language pattern is identified. For example, typical second-class program patterns include events, asynchronous computations, and properties. At numeral 520, the conversion of the second-class program pattern to a first-class program language pattern that operates over push-based data is initiated. Conversion can be accomplished by converting a pattern or element thereof to special first-class types such as “IObservable” or “IProperty.” Conversion to such a type means the pattern is now first class as such you can put events, properties or other entities in arrays or return them from methods, among other things. Initiation of conversion can be embodied as generation of code that invokes conversion. In one instance, a conversion method or function can exist and accordingly this method can be invoked. Alternatively, conversion code can be generated and subsequently invoked.

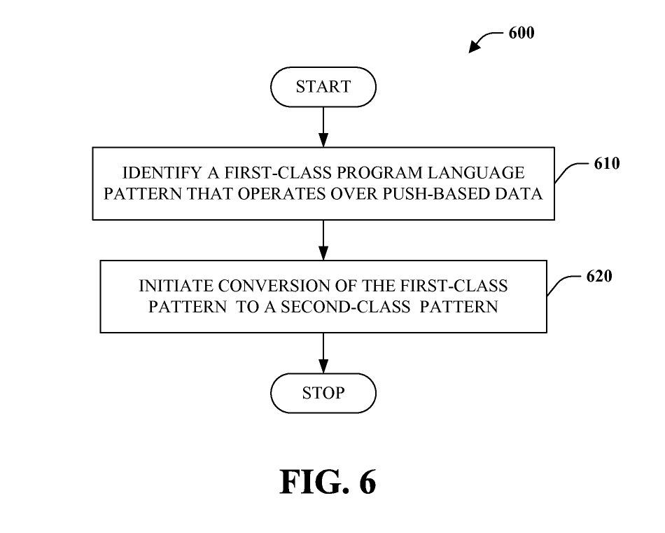

FIG. 6 is a flow chart diagram of a method 600 of converting a first-class pattern to a second-class pattern. At reference numeral 610, a first class program language pattern that operators over push-based data is identified. This can be the case if a language initially supports first-class patterns rather that second-class patterns. At numeral 620, conversion of the first-class program language pattern into a second-class program language pattern is at least initiated. For example, an “IObservable” representation of an asynchronous computation can be transformed into a “BeginInvoke/EndInvoke” pattern. Similar to conversion from a second-class to a first-class pattern, conversion can be embodied as code generation. Furthermore, the code can simply invoke a known conversion method or the like or alternatively generate code to perform the conversion and invoke that code.

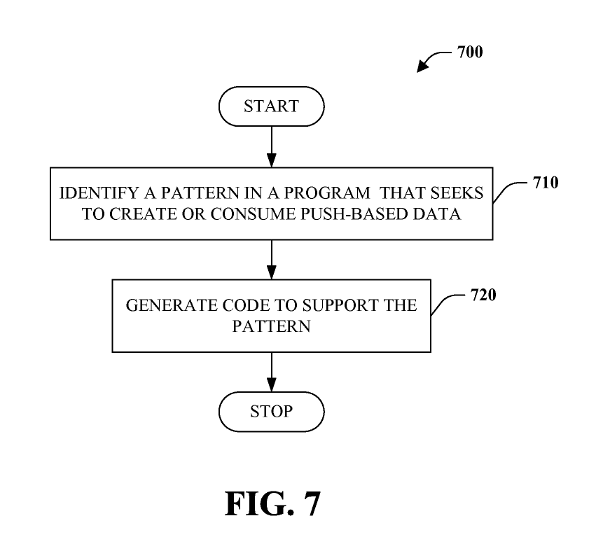

FIG. 7 illustrates a method 700 of facilitating production and consumption of push-based data collections. At reference numeral 710, a pattern in a program is identified that seeks to create and/or consume push-based data. For example, a pattern can be specified by a user that seeks to iterate over a push-based data collection. At 720, support for the pattern can be generated. For instance, a pattern of code typically associated with iteration of pull-based data can be enabled over push-based data by generating code that maps push-based concepts to pull-based concepts and producing a state machine to maintain state across multiple calls.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

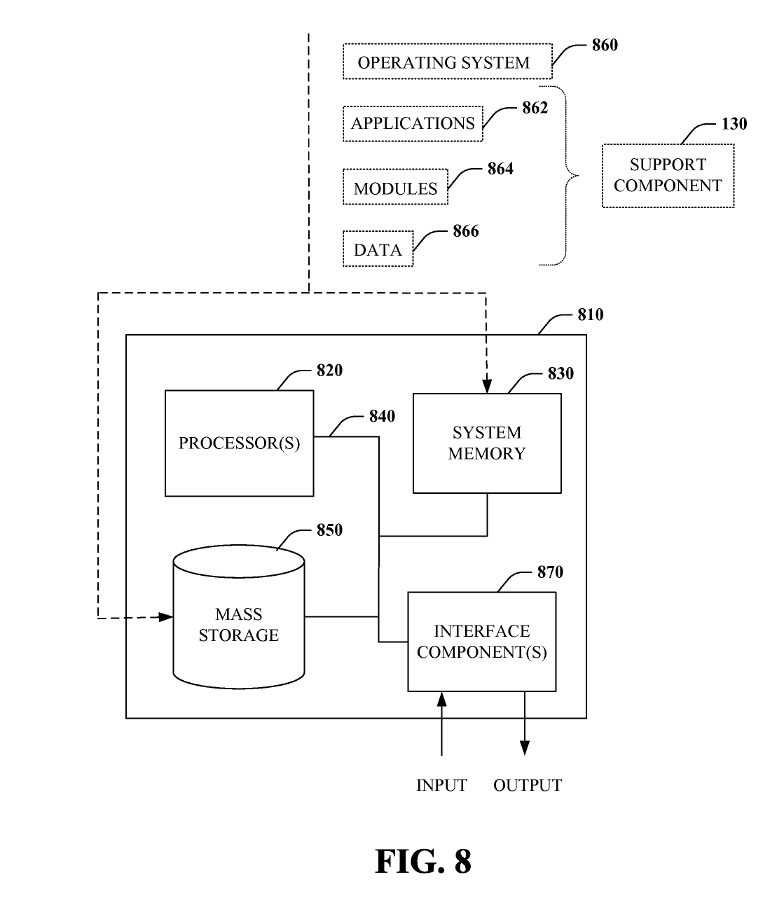

In order to provide a context for the claimed subject matter, FIG. 8 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 8, illustrated is an example general-purpose computer 810 or computing device (e.g., desktop, laptop, server, hand-held, programmable consumer or industrial electronics, set-top box, game system . . . ). The computer 810 includes one or more processor(s) 820, system memory 830, system bus 840, mass storage 850, and one or more interface components 870. The system bus 840 communicatively couples at least the above system components. However, it is to be appreciated that in its simplest form the computer 810 can include one or more processors 820 coupled to system memory 830 that execute various computer executable actions, instructions, and or components.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 810 can include or otherwise interact with a variety of computer-readable media to facilitate control of the computer 810 to implement one or more aspects of the claimed subject matter. The computer-readable media can be any available media that can be accessed by the computer 810 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 810.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 830 and mass storage 850 are examples of computer-readable storage media. Depending on the exact configuration and type of computing device, system memory 830 may be volatile (e.g., RAM), non-volatile (e.g., ROM, flash memory . . . ) or some combination of the two. By way of example, the basic input/output system (BIOS), including basic routines to transfer information between elements within the computer 810, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the system memory 830. For example, mass storage 850 includes, but is not limited to, one or more devices such as a magnetic or optical disk drive, floppy disk drive, flash memory, solid-state drive, or memory stick.

System memory 830 and mass storage 850 can include, or have stored therein, operating system 860, one or more applications 862, one or more program modules 864, and data 866. The operating system 860 acts to control and allocate resources of the computer 810. Applications 862 include one or both of system and application software and can exploit management of resources by the operating system 860 through program modules 864 and data 866 stored in system memory 830 and/or mass storage 850 to perform one or more actions. Accordingly, applications 862 can turn a general-purpose computer 810 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the support component 130 can be, or form part, of an application 862, and include one or more modules 864 and data 866 stored in memory and/or mass storage 850 whose functionality can be realized when executed by one or more processor(s) 820, as shown.

The computer 810 also includes one or more interface components 870 that are communicatively coupled to the system bus 840 and facilitate interaction with the computer 810. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 810 through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., CRT, LCD, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating reactive programming, comprising:
employing at least one processor configured to execute computer-executable instructions stored in memory to perform the following acts:
generating support code for a program that causes a native second-class pattern to be converted into a first-class pattern that operates over push-based data.

2. The method of claim 1, generating support code that causes a second-class event pattern to be converted into a first-class event pattern.

3. The method of claim 1 further comprises identifying syntax in the program that specifies additional functionality supported by the first-class pattern.

4. The method of claim 1, generating support code that causes a second-class asynchronous pattern to be converted into the first-class pattern with a first-class return value.

5. The method of claim 1, generating support code that causes a second-class property to be converted into a first-class property.

6. The method of claim 1, further comprises generating additional code that causes production of first-class pattern of push-based data.

7. The method of claim 1, further comprises generating additional code that enables push-based data to be to be consumed with a pull-based data pattern.

8. The method of claim 1, further comprising generating additional support code for a program that causes the first-class pattern to be converted into the second-class pattern.

9. A program language support system, comprising:
a processor coupled to a memory, the processor configured to execute the following computer-executable components stored in the memory:
a first component configured to provide support code for a program to facilitate utilization of a library that provides functionality to support asynchronous and push-based computations.

10. The system of claim 9, the support code initiates conversion of a second-class pattern into a first-class pattern.

11. The system of claim 10, the support code initiates conversion of an event.

12. The system of claim 10, the support code initiates conversion of asynchronous pattern.

13. The system of claim 10, the support code initiates conversion of a property.

14. The system of claim 9, the support code initiates conversion of a first-class pattern into a second-class pattern.

15. The system of claim 9, the support code encodes an iterator pattern over push-based data.

16. The system of claim 9, the support code generates a producer of push-based data.

17. A computer-readable medium having instructions stored thereon that enables at least one processor to perform the following acts:
providing native programming language support for a program independent reactive library that provides code for composing asynchronous and event-based programs.

18. The computer-readable medium of claim 17 comprising initiating conversion of a second-class pattern to a first-class pattern over push-based data.

19. The computer-readable medium of claim 17 comprising initiating conversion of a first-class pattern to a second-class pattern over push-based data.

20. The computer-readable medium of claim 17, further comprising generating support code for an iterator pattern over push-based data.
